(19) United States
(12) Patent Application Publication
(10) Pub. No.: US 2016/0039079 A1
(43) Pub. Date: Feb. 11, 2016

(54) HYDRAULIC HAMMER HAVING SINGLE PIECE SEAL ASSEMBLY

(71) Applicant: Caterpillar Inc., Peoria, IL (US)

(72) Inventor: Cody MOORE, Waco, TX (US)

(73) Assignee: CATERPILLAR INC., Peoria, IL (US)

(21) Appl. No.: 14/456,994

(22) Filed: Aug. 11, 2014

(51) Int. Cl. B25D 9/04; F16J 9/12; F16J 15/32; F16J 15/00

(52) U.S. Cl. CPC B25D 9/04; F16J 15/002; F16J 9/12; F16J 15/3232; F16J 15/3268; F16J 15/3252

(57) ABSTRACT

A seal assembly for a hydraulic hammer is disclosed. The seal assembly may include a seal carrier having at least one annular recess. The seal assembly may also include at least one seal integrally molded onto surfaces of the at least one annular recess.

### TECHNICAL FIELD

The present disclosure is directed to a hydraulic hammer and, more particularly, to a hydraulic hammer having a single piece seal assembly.

### BACKGROUND

Hydraulic hammers can be attached to various machines such as excavators, backhoes, tool carriers, or other like machines for the purpose of milling stone, concrete, and other construction materials. The hydraulic hammer is mounted to a boom of the machine and connected to a hydraulic system. High pressure fluid in the hydraulic system is supplied to the hammer to drive a reciprocating piston in contact with a work tool, which in turn causes the work tool to reciprocate while in contact with the construction material.

The piston is usually included within an impact system that is surrounded and protected by an outer housing. The impact system also includes a valve that controls fluid to and away from the piston, and an accumulator that provides a reservoir of the fluid at the valve. One or more passages connect the valve with the accumulator. Additionally, one or more seals are installed within the impact system to help secure its components and provide sealing to and from the one or more passages.

An exemplary hydraulic hammer having seals is disclosed in U.S. Pat. No. 8,424,614 (the '614 patent) that issued to Henriksson on Apr. 23, 2013. Specifically, the '614 patent discloses a hydraulic hammer including a housing having a longitudinal bore, a cylinder sleeve supported in the bore, and a hammer piston reciprocally powered in the sleeve for delivering blows to a working implement. The hydraulic hammer also includes a seal ring disposed around a rear end of the piston sealingly guide the piston within the sleeve.

Although the hydraulic hammer of the '614 patent may be adequate for some applications, it may still be less than optimal. In particular, the seal-ring of the '614 patent must be installed correctly within the hydraulic hammer in order for the hammer to function properly. For example, if the seal-ring, is positioned and/or oriented incorrectly, leakage of fluid can occur, and thus, the hydraulic hammer will not function properly. In addition, installation of the seal-ring can require significant labor time and costs.

The disclosed hydraulic hammer is directed to overcoming one or more of the problems set forth above and/or other problems of the prior art.

### SUMMARY

In one aspect, the present disclosure is directed to a seal assembly for a hydraulic hammer. The seal assembly may include a seal carrier having at least one annular recess. The seal assembly may also include at least one seal integrally molded onto surfaces of the at least one annular recess.

In another aspect, the present disclosure is directed to a seal assembly for a hydraulic hammer. The seal assembly may include a seal carrier fabricated from a non-metallic material. The seal carrier may have a first inner annular recess, and a second inner annular recess positioned gravitationally lower than the first inner annular recess. The seal assembly may also include a first unidirectional seal integrally molded onto surfaces of the first inner annular recess, and a second unidirectional seal integrally molded onto surfaces of the second inner annular recess.

In yet another aspect, the present disclosure is directed to a hydraulic hammer system. The hydraulic hammer system may include a frame, a piston, an accumulator membrane disposed external and co-axial to the piston, a sleeve disposed between the piston and the accumulator membrane, a valve located at an axial end of the accumulator membrane and inward of the sleeve, and a sleeve liner disposed between the accumulator membrane and the sleeve. The hydraulic hammer system may also include a seal assembly. The seal assembly may include a seal carrier co-axial with and located axially adjacent to the valve. The seal carrier may be fabricated from a non-metallic material and have a first inner annular recess, and a second inner annular recess positioned gravitationally lower than the first inner annular recess. The seal assembly may also include a first unidirectional seal integrally molded onto surfaces of the first inner annular recess, and a second unidirectional seal integrally molded onto surfaces of the second inner annular recess.

### BRIEF DESCRIPTION OF THE DRAWINGS

FIG. 1 is a pictorial illustration of an exemplary disclosed machine;

FIG. 2 is an exploded view illustration of an exemplary disclosed hydraulic hammer assembly that may be used with the machine of FIG. 1; and

FIG. 3 is a cross-sectional view illustration of an exemplary disclosed seal assembly that may be used with the hydraulic hammer assembly of FIG. 2.

### DETAILED DESCRIPTION

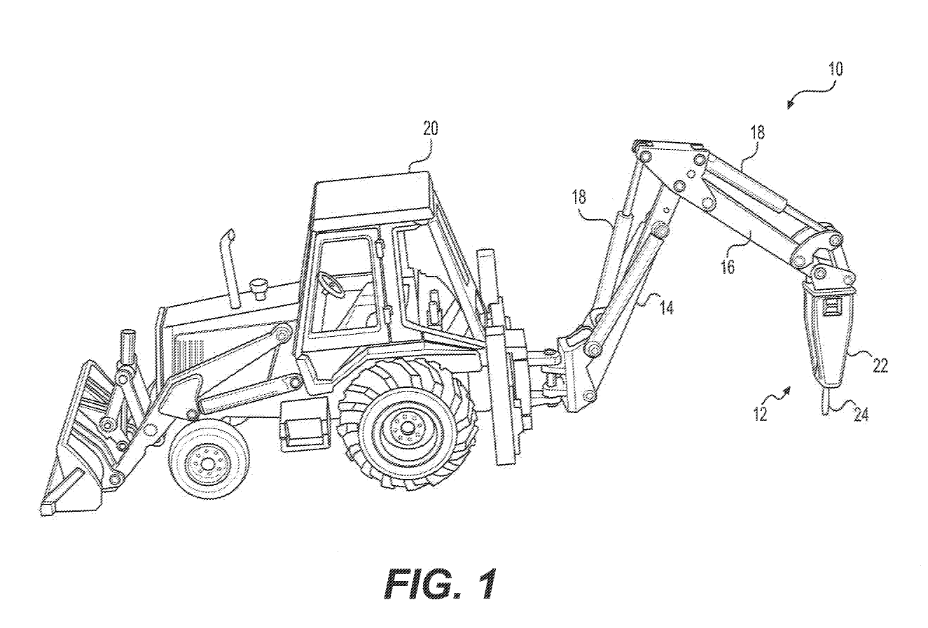

FIG. 1 illustrates an exemplary disclosed machine 10 having a hammer 12. Machine 10 may be configured to perform work associated with a particular industry such as, for example, mining or construction. Machine 10 may be a backhoe loader (shown in FIG. 1), an excavator, a skid steer loader, or any other machine. Hammer 12 may be pivotally connected to machine 10 through a boom 14 and a stick 16. However, it is contemplated that another linkage arrangement may alternatively be utilized, if desired.

In the disclosed embodiment, one or more hydraulic cylinders 18 may raise, lower, and/or swing boom 14 and stick 16 to correspondingly raise, lower, and/or swing hammer 12. The hydraulic cylinders 18 may be connected to a hydraulic supply system (not shown) within machine 10. Specifically, machine 10 may include a pump (not shown) connected to hydraulic cylinders 18 and to hammer 12 through one or more hydraulic supply lines (not shown). The hydraulic supply system may introduce pressurized fluid, for example oil, from the pump into the hydraulic cylinders 18 and hammer 12. Operator controls for movement of hydraulic cylinders 18 and/or hammer 12 may be located within a cabin 20 of machine 10.

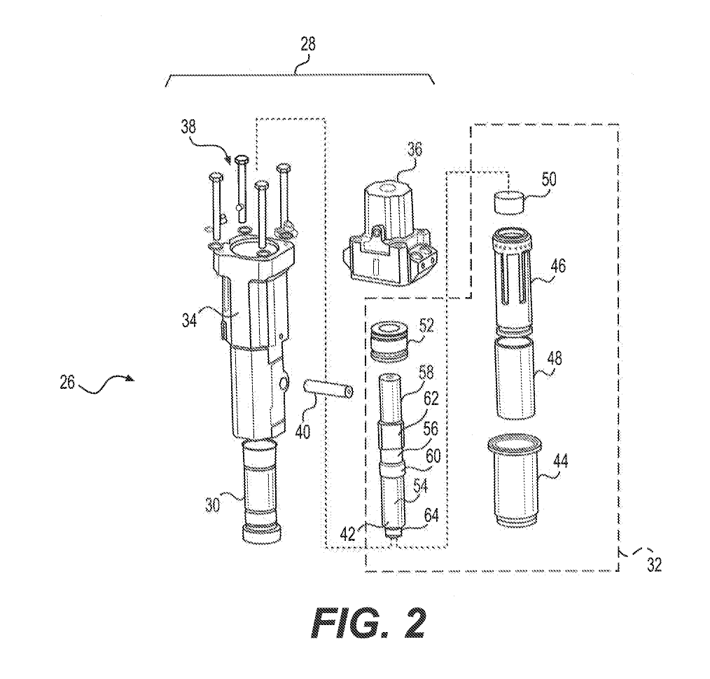

As shown in FIGS. 1 and 2, hammer 12 may include an outer shell 22 and an actuator assembly 26 located within outer shell 22. Outer shell 22 may connect actuator assembly 26 to stick 16 and provide protection for actuator assembly 26. A work tool 24 may be operatively connected to an end of actuator assembly 26 opposite stick 16. It is contemplated that work tool 24 may include any known tool capable of interacting with hammer 12. In one embodiment, work tool 24 includes a chisel bit.

As shown in FIG. 2, actuator assembly 26 may include a subhousing 28, a bushing 30, and an impact system 32. Subhousing 28 may include, among other things, a frame 34 and a head 36. Frame 34 may be a hollow cylindrical body having one or more flanges or steps along its axial length. Head 36 may cap off one end of frame 34. Specifically, one or more flanges on head 36 may couple with one or more flanges on frame 34 to provide a sealing engagement. One or more fastening mechanisms 38 may rigidly attach head 36 to frame 34. In some embodiments, fastening mechanisms 38 may include, for example, screws, nuts, bolts, or any other means capable of securing the two components. Additionally, frame 34 and head 36 may each include holes to receive fastening mechanisms 38.

Bushing 30 may be disposed within a tool end of subhousing 28 and may be configured to connect work tool 24 to impact system 32. A pin 40 may connect bushing 30 to work tool 24. When displaced by hammer 12, work tool 24 may be configured to move a predetermined axial distance within bushing 30.

Impact system 32 may be disposed within an actuator end of subhousing 28 and be configured to move work tool 24 when supplied with pressurized fluid. As shown by the dotted lines in FIG. 2, impact system 32 may be an assembly including a piston 42, an accumulator membrane 44, a sleeve 46, a sleeve liner 48, a valve 50, and a seal carrier 52. One or more seals (not shown in FIG. 2) may be integrally molded to seal carrier 52, as will be discussed in greater detail below.

Sleeve liner 48 may be assembled within accumulator membrane 44, sleeve 46 may be assembled within sleeve liner 48, and piston 42 may be assembled within sleeve 46. All of these components may be generally co-axial with each other. In addition, piston 42, sleeve 46, valve 50, and seal carrier 52 may all be held together as a sub-assembly at least in part by way of slip-fit radial tolerances. For example, slip-fit radial tolerances may be formed between sleeve 46 and piston 42, and between seal carrier 52 and piston 42. Sleeve 46 may apply an inward radial pressure on piston 42, and seal carrier 52 may apply an inward radial pressure on piston 42. Such a configuration may help to hold sleeve 46, seal carrier 52, and piston 42 together as a sub-assembly.

Accumulator membrane 44 may form a cylindrical tube configured to hold a sufficient amount of pressurized fluid for hammer 12 to drive piston 42 through at least one stroke. Accumulator membrane 44 may be radially spaced apart from sleeve 46 when accumulator membrane 44 is in a relaxed state (i.e. not under pressure from pressurized gas). However, when accumulator membrane 44 is under pressure from the pressurized gas, no spacing may exist between accumulator membrane 44 and sleeve 46, and fluid flow therebetween may be inhibited.

Valve 50 may be assembled over an end of piston 42 and located radially inward of both sleeve 46 and seal carrier 52. A portion of seal carrier 52 may axially overlap with sleeve 46. Additionally, valve 50 may be disposed axially external to accumulator membrane 44. Valve 50 and seal carrier 52 may be located entirely within head 36. Accumulator membrane 44, sleeve 46, and sleeve liner 48 may be located within frame 34. Head 36 may be configured to close off an end of sleeve 46 when connected to frame 34.

Piston 42 may be configured to slide within both frame 34 and head 36. For example, piston 42 may be configured to reciprocate within frame 34 and contact an end of work tool 24. Specifically, a compressible gas (e.g., nitrogen gas) may be disposed in a gas chamber (not shown) located within head 36 at an end of piston 42 opposite bushing 30. Piston 42 may be slideably moveable within the gas chamber to increase and decrease the size of the gas chamber. A decrease in size of the gas chamber may increase the gas pressure within the gas chamber, thereby driving piston 42 downward to contact work tool 24.

Piston 42 may comprise varying diameters along its length, for example one or more narrow diameter sections disposed axially between wider diameter sections. In the disclosed embodiment, piston 42 includes three narrow diameter sections 54, 56, 58, separated by two wide diameter sections 60, 62. Narrow diameter sections 54, 56, 58 may cooperate with sleeve 46 to selectively open and close fluid pathways within sleeve 46. Piston 42 may further include an impact end 64 having a smaller diameter than any of narrow diameter sections 54, 56, 58. Impact end 64, may be configured to contact work tool 24 within bushing 30.

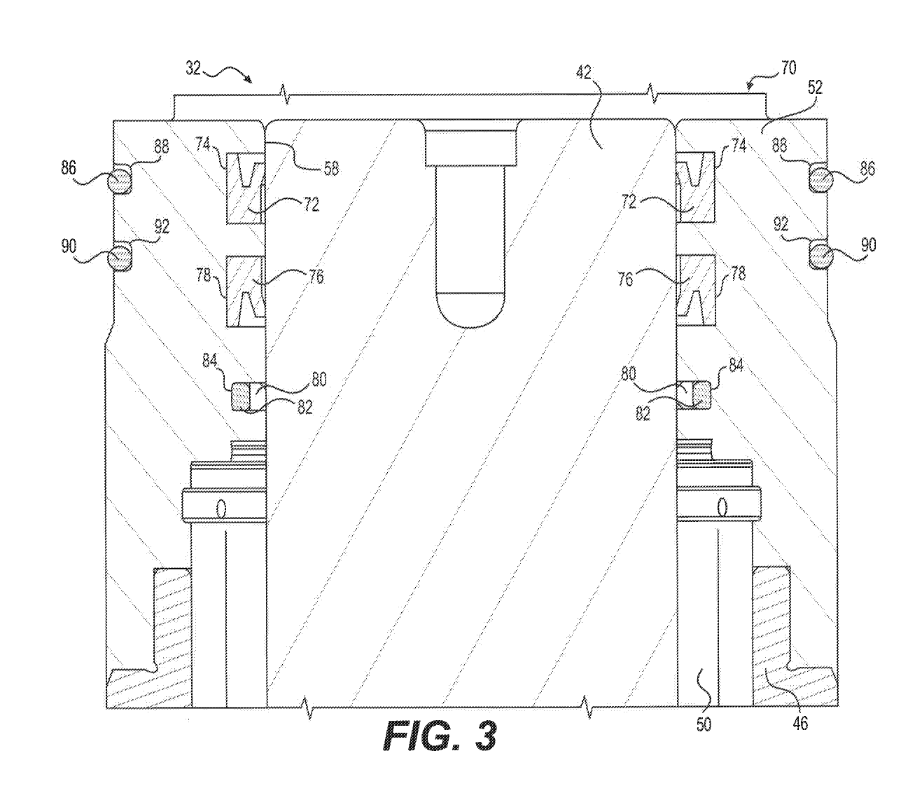

As shown in FIG. 3, hydraulic hammer 12 may be equipped with a seal assembly 70 to secure piston 42, sleeve 46, and seal carrier 52 together as a sub-assembly and to provide sealing between those components. Seal assembly 70 may include seal carrier 52 and one or more seals integrally molded onto seal carrier 52 to simplify assembly. Each seal may be provided within one or more recesses of seal carrier 52. For example, seal assembly 70 may include a first seal 72 molded onto surfaces of a first inner annular recess 74 of seal carrier 52, and a second seal 76 molded onto surfaces of a second inner annular recess 78 of seal carrier 52. In one embodiment, recess 78 may be positioned gravitationally lower than recess 74. For the purposes of this disclosure, gravitationally lower may refer to a respective position once hammer 12 is assembled to a linkage of machine 10 and configured for use (e.g., as shown in FIG. 1). In the disclosed embodiment, seals 72, 76 may be permanently attached to seal carrier 52 after a manufacturing process, such that seals 72, 76 and seal carrier 52 are integrally formed as a single piece assembly. By having a single piece assembly, time and costs associated with installation of the seals may be eliminated, thereby simplifying assembly of hammer 12. In addition, problems associated with improper installation and incorrect alignment of the seals may also be eliminated.

In some embodiments, seals 72, 76 may include unidirectional seals (e.g., U-cup seals) disposed between seal carrier 52 and piston 42. For example, seal 72 may have a U-shaped portion oriented generally upwards with respect to gravity, while seal 76 may have a U-shaped portion oriented generally downwards with respect to gravity. The U-cup seals may cause less friction between piston 42 and seal carrier 52, as opposed to, for instance, O-ring seals, and thus, less heat and wear of the seals is produced. Seals 72, 76 may help to secure the sub-assembly, such that valve 50 moves up and down properly within impact system 32. For example, seals 72, 76 may be compressed to generate a radial force on seal carrier 52 and piston 42 that secures seal carrier 52 to piston 42.

Also shown in FIG. 3, seal assembly 70 may further include a third seal 80 and a fourth seal 82 molded onto surfaces of a third inner annular recess 84 of seal carrier 52. In one embodiment, recess 84 may be positioned gravitationally lower than recesses 74, 78. In some embodiments, seal 80 may be molded onto seal 82, and seal 82 may he molded onto the surfaces of recess 84. Like seals 72, 76, seals 80, 82 may also help to secure the sub-assembly, such that valve 50 moves up and down properly within impact system 32.

In some embodiments, seal carrier 52 may be fabricated from a non-metallic material (e.g., a plastic material including, for example, a high-temperature plastic). A plastic material seal carrier may be cheaper than a typical cast iron seal carrier. Also, the plastic material may have properties that are more suitable for molding seals 72, 76, 80, 82 onto seal carrier 52. Seals 72, 76, 82 may be fabricated from a rubber or polyurethane material, while seal 80 may be fabricated from a nylon material. During manufacture, seals 72, 76, 82 may be permanently molded onto seal carrier 52 using, for example, any bonding agent known in the art that is commonly used for molding plastic and rubber or polyurethane materials together. Similarly, seal 80 may be permanently molded onto seal 82 using, for example, any bonding agent known in the art that is commonly used for molding rubber or polyurethane and nylon materials together.

In some embodiments, a fifth seal 86 may be disposed in a first outer annular recess 88 of seal carrier 52, while a sixth seal 90 may be disposed in a second outer annular recess 92 of seal carrier 52. In the disclosed embodiment, seals 86, 90 are not integrally molded onto seal carrier 52. However, it is contemplated that seals 86, 90 may be integrally molded onto seal carrier 52, if desired. Seals 86, 90 may be in the form of O-rings made from a rubber or polyurethane material. Like seals 72, 76, 80, 82, seals 86, 90 may also help to secure the sub-assembly, such that valve 50 moves up and down properly within impact system 32.

It is contemplated that, although seals 72, 76, 80, 82 are described herein as being made from different materials than seal carrier 52, the seals may alternatively be integrally fabricated from the same material as seal carrier 52. For example, seal assembly 70 may be entirely made of a plastic material. This configuration may further simplify manufacture and assembly processes by providing a cheaper and simpler replacement part. Assembly and replacement of seal assembly 70 will be described in more detail in the section below.

### INDUSTRIAL APPLICABILITY

The disclosed seal assembly may be used in any hydraulic hammer application. The disclosed seal assembly may be installed and removed from the hammer as a single piece assembly. More specifically, the seal assembly, being a single piece assembly, may not require placement of individual seals during assembly of the hammer. Instead, the seal assembly as a whole may be a drop-in replacement assembly, which can help reduce service and downtime of the machine. Assembly and replacement of seal assembly 70 during servicing of machine 10 will now be described in detail.

Assembly of seal assembly 70 onto hammer 12 may include sliding seal assembly 70 over narrow diameter section 58 and arranging it external and co-axial to piston 42. Seals 72, 76, 80, 82 may be compressed during this assembly, and thereby secure seal carrier 52 to piston 42. Accordingly, seal assembly 70 may be held together as a single piece assembly, such that no individual seal installation is required.

Seal assembly 70 may be removed from hammer 12 as a single piece assembly to facilitate faster service and low downtime of machine 10. For example, upon failure of any component of seal assembly 70 (e.g., seal 72), instead of breaking down seal assembly 70 piece-by-piece until seal 72 is exposed, seal assembly 70 may be removed as a single piece assembly and replaced with another seal assembly 70. Specifically, hammer 12 may be removed from a linkage of machine 10, and actuator assembly 26 may be removed from outer shell 22. Therefore, head 36, frame 34, and impact system 32 may be removed from outer shell 22. Head 36 may then be removed from frame 34 to expose impact system 32. Hammer 12 may be removed from the linkage before head 36 is removed from frame 34. A user may remove seal assembly 70, from frame 34, as a single piece assembly and place a new seal assembly 70 into frame 34. Head 36 may be reassembled with frame 34, and then actuator assembly 26 may be re-installed into outer shell 22. Hammer 12 may be re-assembled to the linkage of machine 10 after head 36 has been re-assembled to frame 34.

The entire seal assembly 70 may be disposed and replaced with a new seal assembly 70. As discussed above, seal carrier 52 may be made of a plastic material, which is cheaper than its metal substitutes, and therefore, replacement costs may be reduced. In some situations, the failed component, for example, seal 72, may be serviced in a shop at a later time, after seal assembly 70 has been removed from frame 34 and the new seal assembly 70 placed into frame 34. Therefore, seal 72 may be serviced at a slower pace without affecting the downtime of machine 10.

The present disclosure may provide a hydraulic hammer having a single piece seal assembly that may be installed and removed from the hammer as one integral component. Therefore, a user may no longer be required to install individual seals onto the hammer. This may reduce cost and time to repair the hammer and may reduce downtime of the machine associated with the hammer. Additionally, problems associated with misalignment of the seals may be significantly reduced.

It will be apparent to those skilled in the art that various modifications and variations can be made to the hydraulic hammer of the present disclosure. Other embodiments of the hydraulic hammer will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A seal assembly for a hydraulic hammer, the seal assembly comprising;
a seal carrier having at least one annular recess; and
at least one seal integrally molded onto surfaces of the at least one annular recess.

2. The seal assembly of claim 1, wherein the seal carrier is fabricated from a non-metallic material.

3. The seal assembly of claim 1, wherein the at least one seal includes:
a first seal integrally molded onto surfaces of a first inner annular recess of the seal carrier; and
a second seal integrally molded onto surfaces of a second inner annular recess of the seal carrier, the second inner annular recess being positioned gravitationally lower than the first inner annular recess.

4. The seal assembly of claim 3, wherein the first and second seals are fabricated from at least one of a rubber material or a polyurethane material.

5. The seal assembly of claim 3, wherein the first and second seals are unidirectional seals.

6. The seal assembly of claim 5, wherein:
the first seal includes a U-shaped portion oriented generally upwards with respect to gravity; and
the second seal includes a U-shaped portion oriented generally downwards with respect to gravity.

7. The seal assembly of claim 3, further including:
a third seal integrally molded onto surfaces of a third inner annular recess of the seal carrier, the third inner annular recess being positioned gravitationally lower than both the first and second inner annular recesses; and
a fourth seal integrally molded onto the third seal.

8. The seal assembly of claim 7, wherein the third seal is fabricated from at least one of a rubber material or a polyurethane material, and the fourth seal is fabricated from a nylon material.

9. The seal assembly of claim 7, further including:
a fifth seal disposed within a first outer annular recess of the seal carrier; and
a sixth seal disposed within a second outer annular recess of the seal carrier, the second outer annular recess being positioned gravitationally lower than the first outer annular recess.

10. The seal assembly of claim 1, wherein the seal carrier and the at least one seal are both fabricated from the same material.

11. A seal assembly for a hydraulic hammer, the seal assembly comprising:
a seal carrier fabricated from a non-metallic material, the seal carrier having:
a first inner annular recess; and
a second inner annular recess positioned gravitationally lower than the first inner annular recess;
a first unidirectional seal integrally molded onto surfaces of the first inner annular recess; and
a second unidirectional seal integrally molded onto surfaces of the second inner annular recess.

12. The seal assembly of claim 11, wherein the first and second seals are fabricated from at least one of a rubber material or a polyurethane material.

13. The seal assembly of claim 11, wherein:
the first seal includes a U-shaped portion oriented generally upwards with respect to gravity; and
the second seal includes a U-shaped portion oriented generally downwards with respect to gravity.

14. The seal assembly of claim 11, further including:
a third seal integrally molded onto surfaces of a third inner annular recess of the seal carrier; and
a fourth seal integrally molded onto the third seal.

15. The seal assembly of claim 14, wherein the third seal is fabricated from at least one of a rubber material or a polyurethane material, and the fourth seal is fabricated from a nylon material.

16. A hydraulic hammer system, comprising:
a frame;
a piston;
an accumulator membrane disposed external and co-axial to the piston;
a sleeve disposed between the piston and the accumulator membrane;
a valve located at an axial end of the accumulator membrane and inward of the sleeve;
a sleeve liner disposed between the accumulator membrane and the sleeve; and
a seal assembly having:
a seal carrier co-axial with and located axially adjacent to the valve, the seal carrier being fabricated from a non-metallic material and having a first inner annular recess, and a second inner annular recess positioned gravitationally lower than the first inner annular recess;
a first unidirectional seal integrally molded onto surfaces of the first inner annular recess; and
a second unidirectional seal integrally molded onto surfaces of the second inner annular recess.

17. The hydraulic hammer system of claim 16, wherein the first and second seals are fabricated from at least one of a rubber material or a polyurethane material.

18. The hydraulic hammer system of claim 16, wherein:
the first seal includes a U-shaped portion oriented generally upwards with respect to gravity; and
the second seal includes a U-shaped portion oriented generally downwards with respect to gravity.

19. The hydraulic hammer system of claim 16, further including:
a third seal integrally molded onto surfaces of a third inner annular recess of the seal carrier; and
a fourth seal integrally molded onto the third seal.

20. The hydraulic hammer system of claim 19, wherein the third seal is fabricated from at least one of a rubber material or a polyurethane material, and the fourth seal is fabricated from a nylon material.
